(19) United States
(12) Patent Application Publication
(10) Pub. No.: US 2007/0264004 A1
(43) Pub. Date: Nov. 15, 2007

(54) MULTIPLE IMAGE MOSAIC PHOTOGRAPH CAMERA MOUNT AND METHOD

(76) Inventor: George D. Daggett, Englewood, CO (US)

Correspondence Address: SHERIDAN ROSS PC, 1560 BROADWAY, SUITE 1200, DENVER, CO, 80202, US

(21) Appl. No.: 11/382,743

(22) Filed: May 11, 2006

(51) Int. Cl. G03B 17/00; G03B 41/00

(52) U.S. Cl. 396/322; 396/428

(57) ABSTRACT

A camera mount and method of using such a mount are provided herein. The camera mount allows a camera to be rotated about a first and second axis such that a complete panoramic picture may be taken of an object. Moreover, the camera mount is equipped with calibrations for controlled rotation about the first and second axis. Thus, a user can take multiple pictures at each of the calibrated positions along both axes and place the pictures together to form a panoramic picture with or without the aid of sophisticated image processing techniques.

### FIELD

The present invention is directed toward a camera mount and methods of using such a camera mount. More specifically, a camera mount is provided that allows a user to easily and accurately take multiple images of an object and combine the images into a larger picture of the object.

### BACKGROUND

Cameras have long been used to capture a moment in time that can be cherished and shared forever. The idea of taking a picture is to share that moment in time with others that may not have been there. When people go on vacation, they typically take pictures of the wonderful scenery or buildings that they encounter along the way. They would like the picture to accurately show what it was like to look down the canals of Venice or admire the Rocky Mountains first hand. Unfortunately, cameras have a limited field of view. Therefore, the picture taken to reflect the moment only reflects a portion of that moment.

In an attempt to address this dilemma, specialized panoramic cameras and methods of producing a panoramic picture have been developed. These panoramic solutions are able to gain a large perspective in one plane (typically the horizontal plane). The field of view of panoramic cameras in the horizontal plane is typically much larger than the field of view of standard cameras. Due to this fact, the panoramic camera is able to capture a larger portion of the object that is being photographed. However, the same problems of the standard camera exist with the panoramic camera in that there is a limited field of view and a picture can only be taken of a portion of an object.

A potential solution to such a problem would be to take multiple pictures of each portion of the same object. Alternatively, a person could stand in one place and take multiple pictures of his/her entire surroundings. This collection of pictures may begin to help convey the beauty or intrigue of a particular scene. The problem that has been encountered with taking multiple pictures is that it is very difficult to properly take each picture such that it can be aligned after the picture has been developed and to do so in a fashion and within time constraints imposed by either the subject matter, lighting conditions, etc.

Certain problems in the camera field have been addressed by a digital image processing technique known as “stitching.” Stitching in its basic form combines two pictures that have been taken with some overlap between the two pictures. Objects in the pictures are identified by software and the pictures are brought together in an attempt to complete those objects that overlap between the first picture and the second picture. For most pictures this requires a substantial amount of skill in shooting the individual pictures to perfectly align the pictures such that there does not appear to be an image disruption between the first picture and the second picture.

Stitching and other image processing techniques are useful and serve a broad purpose. More advanced photographers may want to stitch images captured with the camera mounted in a horizontal position and in multiple rows.

Stitching may not be well suited for novice photographers that simply want to point and click. Many photographers, whether using a digital camera or traditional film cameras, would like to be able to produce an assemblage of images by simply placing or taping them together side-by-side. Such an edge-to-edge collection of images may be known as a mosaic. To this point there has not been a solution that allows photographers to easily point and click, then print the pictures and place them next to one another and especially in more than just a horizontal expanse to form a mosaic of a particular scene.

### SUMMARY

It is therefore an object of the present invention to provide a camera mount and to describe the method of using the camera mount that allows a user to create a multiple image composite photograph with or without the assistance of stitching. One aspect of the present invention provides a method for creating a printed multiple image mosaic. One embodiment is directed to a method comprising the steps of:

positioning a camera at a first point;

taking a first picture with the camera positioned at the first point;

moving the camera to a second point a calibrated angle away from the first point on a first axis;

taking a second picture with the camera positioned at the second point;

moving the camera to a third point a calibrated angle away from at least one of the first and second point on a second axis; and

taking a third picture with the camera positioned at the third point.

In one embodiment of the present invention a user of the camera is able to easily identify the calibrations between the first, second, and third positions. Because of this fact, the user can move the camera from one position to the next relatively quickly and with assurance that one picture will continue substantially at where the previous one left off. Thus, after the pictures have been printed the user can easily place one picture next to another picture and the two pictures will look substantially like a single picture.

Another embodiment is to zoom out so as to capture some degree of overlap between adjacent exposures, which enables the digital stitching of the set into a seamless composite.

One advantage offered by the present invention is the fact that a mosaic can be produced with superior resolution. A problem with a single digital panoramic picture is that it can be enlarged only so far before the picture begins to look pixilated. Of course one can use a higher resolution digital camera but there is still a point where the picture will get too big and the image will begin to appear pixilated. However, a large mosaic of smaller pictures that have not been pixilated will appear like one large picture with exceptional resolution. It should be understood, however, that various embodiments of the present invention may employ traditional/conventional film and/or digital images.

In accordance with at least one embodiment of the present invention another method is provided for creating a mosaic image, the method comprising the steps of:

defining at least two positions a calibrated angle apart on a first plane;

taking a picture at each of the at least two positions on the first plane;

defining a second plane a calibrated angle offset from the first plane;

defining at least two positions on the second plane; and

taking a picture at each of the at least two positions on the second plane.

The ability to take pictures from at least two calibrated positions on a first plane and then take more pictures from at least two calibrated positions on a second plane, affords the photographer an ability to create a mosaic image of his/her entire surroundings including the sky, the ground, and all of the landscape around him/her. Most photography techniques typically only take pictures across one plane (most often the horizontal plane). Thus, techniques of the prior art have only assisted the user in moving a camera from one position to the next along one plane. However, if one wishes to capture the perspective of his/her entire surroundings (or more than just one “picture view” plane of a horizon, then techniques of the prior art are ill-suited for such purpose. In accordance with at least some embodiments of the present invention, a user can take a set of pictures along one plane, for example, a first horizontal plane. Each of the pictures taken along the first horizontal plane will have been taken from calibrated positions such that the user can easily combine the pictures to form a mosaic after the pictures have been printed.

After the first horizontal plane has been captured by two or more pictures the user can adjust the camera by a calibrated angle, either up or down, to a second plane that continues almost precisely where the first plane left off. On the second plane the user can take pictures from calibrated positions in a similar fashion to the first plane. Thereafter, the pictures from the first plane can be combined with the pictures from the second plane to form a two-dimensional mosaic from one picture to the next and from one plane to the next.

A further aspect of the present invention provides for an automation of the above noted methods. The capturing and subsequent movement of a camera may be automated and completed without substantial human interaction. For example, the use of servomotors in conjunction with a controller could effectively be used to automate the process. The controller may be programmed with calibrated angles of movement, and can further control the camera such that the camera takes a picture between and/or on each calibrated angle of movement. After each picture has been taken the controller sends signals to the servomotors, thus initiating a controlled movement of the camera from one calibrated position to the next calibrated position. Once in the next calibrated position, the controller directs the camera to take another picture. This process can be repeated by the cooperation of the controller and servomotors until the desired number of pictures have been taken, in the desired planes (e.g., across 180 degrees of a horizon; and four pictures “high” along the vertical plane, etc.).

In accordance with at least some embodiments of the present invention a camera mount is provided that enables a user to create mosaic images. The camera mount comprises:

a base with calibrations for controlled movement about a first axis;

a swing mount having calibrations for controlled movement about a second axis; and

wherein the swing mount is rotatable about the first axis relative to the base and is further rotatable about the second axis.

The camera mount is operable to rotate a camera about at least two axes that substantially intersect with the optical nodal point of the camera to avoid parallax shift between successive exposures. Because the camera is rotated about its nodal point with two rotational degrees of freedom, a user can easily capture all of his/her surroundings with precise alignment or overlap between adjacent exposures.

An example of a camera mount that affords movement of a camera about two or more axes is shown in U.S. Pat. No. 4,341,452 to Korling, the entire disclosure of which is hereby incorporated herein by reference. The camera mount of Korling provides a triaxial camera mount that has pivot construction such that a camera is balanced in the mount and which permits angular movement of the camera to any position without changes focus or introduction of parallax shift. A drawback to the camera mount described in Korling is that the mount is not intended for use in aligning adjacent shots. Calibrations for controlled movements about the rotational axes are not provided on the mount, thus making the creation of a quality multiple image mosaic very difficult. In contrast with the Korling system, certain embodiments of the present invention include a camera mount equipped with calibrations for controlled movement about each of a first and second axis, thus a user is able to take multiple pictures of an object that can be easily combined later into a printed mosaic or stitched composite without worrying whether or not he/she has moved the camera far enough or not far enough to have the next picture begin where the previous picture left off.

Furthermore, the user of the present invention does not necessarily have to take pictures in sequence, as they may be put together later. In other words, the user may choose to follow the movements of an eagle around a rock cliff. For example, a user can move the camera to a first position and take a picture of the eagle. By the time the user is ready to take the next picture of the eagle, the eagle may not be in an area that coincides with a calibrated position that is adjacent to the first position. Instead, the next position may be two calibrated positions away from the first calibrated position. This is not a concern as the user can simply move the camera over two calibrated positions and take another photograph of the eagle. Then the user may move the camera back a calibrated position that is adjacent to the first position and that is also adjacent to the position two calibrated positions away from the first position. The user can wait until the eagle is in this new calibrated position before he/she takes a picture of the eagle. The final product could be a mosaic image with the same eagle in every individual image and with a continuous background.

The bottom of the camera is attached to the bottom of the inner yoke of the swing mount, so the natural position of the camera is in the horizontal position. The design of the swing mount is structurally strong enough to carry virtually any still camera equipment configuration without distortion or displacement of the camera away from its intended intersection between the nodal point and the two axes of rotation.

These and other advantages will be apparent from the disclosure of the invention set forth herein. It is noted that the above-described embodiments arid configurations in this Summary of the Invention are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 is a front view of a camera mount in accordance with embodiments of the present invention;

FIG. 2 is a side view of a camera mount in accordance with embodiments of the present invention;

FIG. 3 is a top view of a camera mount in accordance with embodiments of the present invention;

FIG. 4 is an alternate side view of a camera mount in accordance with embodiments of the present invention;

FIG. 5 is a diagram depicting a mosaic picture of an object constructed in accordance with embodiments of the present invention;

FIG. 6 is a perspective view of a camera mount in accordance with embodiments of the present invention; and

FIG. 7 is a flow diagram depicting a method of creating a mosaic image in accordance with embodiments of the present invention.

### DETAILED DESCRIPTION

Embodiments of the present invention are generally directed toward a moveable mount for a camera. The mount described herein may be used with either analog or digital photographic cameras. Embodiments of the present invention provide for the easy creation and assembly of pictures (either printed as tangible photographs or stored as computer images) with or without image processing techniques. As can be appreciated by one of skill in the art, use of such image processing techniques may further enhance a final mosaic picture rendered through use of embodiments of the present invention described herein.

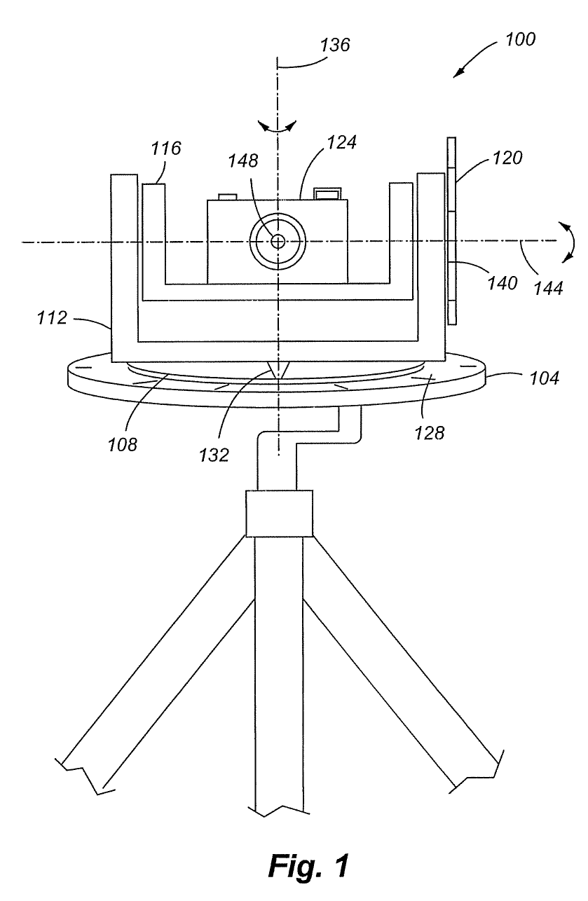

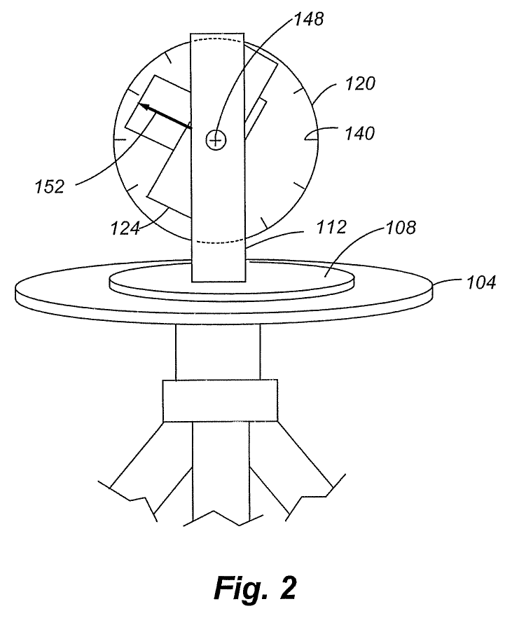

Referring now to FIGS. 1 and 2, a camera mount 100 will be described in accordance with at least some embodiments of the present invention. The camera mount 100 generally comprises a base 104, a pivot member 108, an outer yoke 112, and an inner yoke 116. The pivot member 108 connects the base 104 to the outer yoke 112. The pivot member 108 may be in the form of a friction plate or other type of rotatable element that employs bearings or the like.

A tripod or other typical camera stabilizer typically supports the base member 104, although a table, chair, or any other suitable support may support the base member 104. Alternatively, the base member 104 may be placed directly on the ground. As can be appreciated by one of skill in the art, the base member 104 may be adapted to rest upon any suitable type of support member.

The inner yoke 116 is pivotally connected to the outer yoke 112 through use of a pivot assembly or the like that may include a screw, nut and bolt, washers, rod, bearing assemblies, or any other suitable connection mechanism. The outer yoke 112 and inner yoke 116 collectively form a swing mount. A vertical calibration member 120 is shown as being attached to the outer yoke 112 of the swing mount. Although the calibration member is depicted as being connected to the outer yoke 112, it can be appreciated that the swing mount calibration member 120 may alternatively or additionally be connected to the inner yoke 116. The swing mount is operable to support a camera 124 of just about any make and or model. Types of cameras that may be supported by the swing mount include, but are not limited to, 35 mm single lens reflex cameras (whether film or digital), pocket-sized digital cameras, or any camera designed for still photography. The mount may be adjustable to accommodate cameras of different sizes, utilize adaptors to orient the camera along both axes 136 and 144, or involve specific mounts designed for specific camera and lens combinations.

The camera 124 is attached to the inner yoke 116 via a mounting screw that screws into the tripod socked in the bottom of the camera. In its natural position in the swing mount, the camera is oriented in its horizontal or landscape position, not sideways in the vertical or portrait position.

The swing mount is operable to rotate about the base member 104 via the pivot member 108. When the camera 124 is properly positioned properly on the swing mount, the optical nodal point 148 of the camera 124 can be rotated about a first axis 136 though the movement of the swing mount relative to the base 104. First axis calibrations 128 shown on the base 104 indicate different positions for the camera to be rotated to if a mosaic image is to be constructed. The first axis position indicator 132 shows the user which position the camera 124 is directed toward relative to the first axis 136. The base member 104 comprises calibrations 128 encircling its circumference. In a preferred embodiment, the first axis position indicator 132 is located behind the camera 124 such that a user can easily identify where the camera 124 is positioned with respect to the calibrations 128. However, in an alternative embodiment, a first axis position indicator 132 may be located in front of the camera 124 and/or at any other position around the camera 124.

When the camera 124 is positioned properly, the swing mount is further operable to rotate the nodal point 148 of the camera 124 about a second axis 144. Similar to the base 104, the swing mount calibration member 120 comprises second axis calibrations 140. The second axis calibrations 140 provide an indication of suggested positions for the camera 124 if a multiple row composite image is to be constructed.

The swing mount has 360 degrees of rotational freedom about the first axis 136. Likewise the swing mount allows the camera to have at least 200 degrees of rotational freedom about the second axis 144.

Since the camera 124 is rotated about its nodal point 148 no substantial parallax shift is introduced as a result of rotating the camera 124. As long as the nodal point 148 remains still various pictures taken with the camera 124 can be placed edge-to-edge or stitched together and will seem like a continuous picture.

As can be seen in FIG. 2, the swing mount calibration member 120 may be shaped like a semi-circle or the like, substantially defining second axis calibrations 140 around the second axis 144. A second axis position indicator 152 may also be used in connection with the second axis calibrations 140 to identify various positions for the camera 124 in the event that a multiple row mosaic image is desired. Similar to the swing mount calibration member 120, the second axis position indicator 152 may be mounted on one or both of the inner yoke 116 and outer yoke 112. Alternatively, the position indicators 132 and/or 152 may be mounted on the camera 124. The position indicators 132 and/or 152 simply act to show a user of the mount 100 the current position of the camera 124 relative to the mount 100. Thus, the functionality of the indicators may be achieved through devices not even attached to the mount 100.

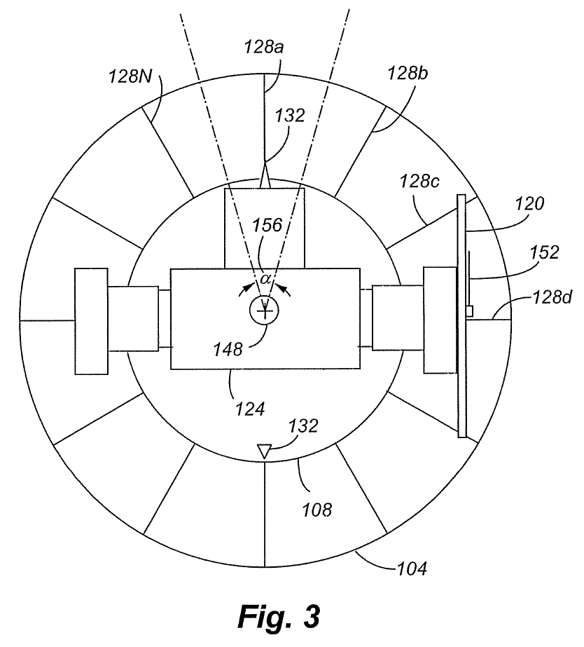

Referring now to FIG. 3, the first axis calibrations 128 will be described in further detail. The first axis calibrations 128a-N, where N is typically greater than or equal to 1, help define positions for the camera 124 to create a set of pictures about the first axis 136 that either substantially overlap or do not have any information missing therebetween. The first axis calibrations 128a, 128b, 128c, and 128d are shown as four sequential positions to which the camera 124 as indicated by the pointer 132 can be positioned moving from left to right. The calibrated angle between each calibration 128 may be substantially equal to the field of view of the camera 124 in the first plane 156.

The field of view in the first plane 156 can be any angle between about 0 and 180 degrees. The horizontal field of view for a 100 mm lens on a 35 mm film camera is roughly 20 degrees. Therefore, in the event that a 100 mm lens is employed on a film camera 124, then the angle between each first axis calibration 128 will be approximately 20 degrees. In the event that a panoramic camera lens, a fisheye lens, or any other type of lens that has a wider horizontal field of view, then the angle between each first axis calibration 128 will be larger than 20 degrees to accommodate for the wider field of view. It can be appreciated by one of skill in the art that the first axis calibrations 128 and the second axis calibration 140 can be changed or adjusted to accommodate for cameras of different field of views.

Assuming that a 100 mm lens is being used, and the horizontal field of view of the camera is about 20 degrees, then there will be eighteen first axis calibrations 128 on the base 104. Each calibration defining a different point for the camera 124 to take pictures that will result in a printed edge-to-edge mosaic that did not require any image processing to produce. Utilizing a lens with a slightly wider field of view along with this set of calibrations will produce images that can be digitally stitched into a seamless composite photograph assuming that the calibration points are left unchanged from the 100 mm lens.

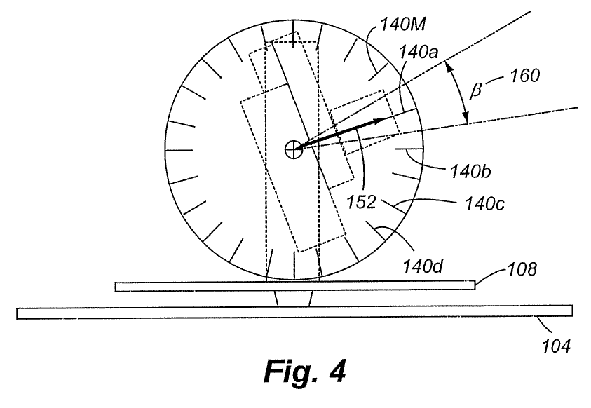

Referring now to FIG. 4, the second axis calibrations 140 of the camera mount 100 will be described in accordance with at least some embodiments of the present invention. The second axis calibrations 140a-M, where M is typically greater than or equal to 1, help define positions for the camera 124 to create a set of pictures about the second axis 144 that, in one embodiment substantially overlap or, in another embodiment do not have any information missing therebetween. The second axis calibrations 140a, 140b, 140c, and 140d are shown as four sequential positions to which the camera 124 can be positioned moving from top to bottom. The calibrated angle between each calibration 140 is substantially equal to the field of view of the camera 124 in the second plane 160.

The field of view in the second plane 160 can be any angle between about 0 and 180 degrees. The vertical field of view for a typical 100 mm lens on a film camera is roughly 13.5 degrees. Therefore, in the event that a 100 mm lens is employed on the camera 124, then the angle between each second axis calibration 140 will be approximately 13.5 degrees. As noted above, the angles between the calibrations 140 may be changed or adjusted depending upon the type of camera lens used and its associated field of view.

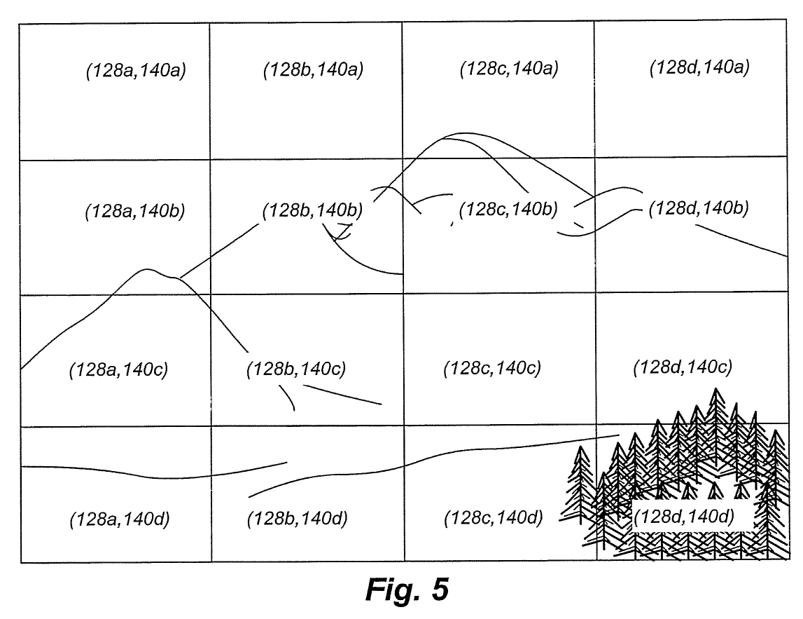

Referring now to FIG. 5 an example mosaic image 200 will be described in accordance with at least some embodiments of the present invention. The multiple image mosaic 200 is a collection of individual images that have been brought edge to edge. The coordinates shown in each picture represent the position the camera was in based on the calibrations 128 and 140 depicted in FIGS. 3 and 4. For example, the image corresponding to the coordinates (128a, 140a) is essentially a picture of sky. The second picture down on the far left of the mosaic 200 was taken with the positional coordinates (128a, 140b) about the first 136 and second 144 axis respectively. This particular image included the top of a mountain. The adjacent image to the right with positional coordinates (128b, 140b) is a continuation of the mountain from the previous picture. Whereas the adjacent image below with the positional coordinates (128a, 140c) is a continuation from the picture above it of a different mountain in the forefront of the image. As the camera is moved from one position to the next, the field of view remains the same and it will not seem like there are substantial discontinuities between images. As can be seen in FIG. 5 the mount 100 provides for the production of a mosaic 200 that is both a horizontal and vertical collection of photographs.

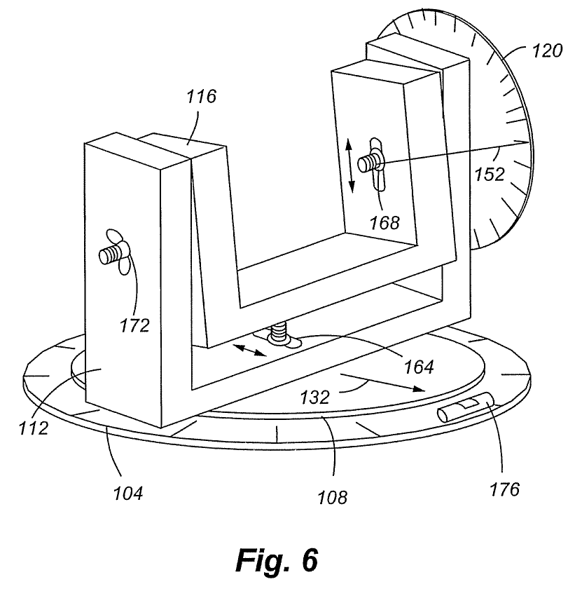

Referring now to FIG. 6, additional features of the camera mount 100 will be described in accordance with at least some embodiments of the present invention. One inventive aspect of the present invention is that, for a given camera, a mosaic image can be constructed using any lens with any size of field of view. This is possible because the camera's position on swing mount may be adjusted forward and back to place the nodal point 148 of any camera incident upon the intersection of the first 136 and second 144 axes. Specifically, an outer yoke adjustment member 164 may be used to translate or otherwise adjust the positioning of the outer yoke 112 relative to the first axis 136. Likewise, an inner yoke adjustment member 168 may be used to translate or otherwise adjust the positioning of the camera 124 relative to the first axis 136 and the second axis 144. Therefore, a lens with larger focal length can be mounted on the camera after having used a lens with a smaller focal length and, after the camera's inner yoke attachment point is properly adjusted, the larger lens can be used to create a mosaic image. The outer yoke adjustment member 164 may comprise a mounting groove on the outer yoke 112 with a securing mechanism that can be moved within the mounting groove. Alternatively, the outer yoke adjustment member 164 may comprise a rail mounted on the swivel assembly 108. The outer yoke 112 may be moved along the rail to compensate for cameras 124 of various sizes. As previously noted, the inner yoke 116 is typically held to the outer yoke 112 through a connector 172 or similar type of pivot assembly. The pivot assembly is depicted as a screw and wing nut, although other types of pivot assemblies may be employed.

The second axis position indicator 152 can be attached to the pivot assembly (either on the inside or the outside) and therefore moves as the inner yoke 116 moves relative to the outer yoke 112. The swing mount calibration member 120 may be substantially fixed relative to the outer yoke 112. Then, as the inner yoke 116 rotates relative to the outer yoke 112, the second axis position indicator 152 moves relative to the swing mount calibration member 120 and various positions of the camera can be identified and used to create a multiple row mosaic image.

The camera mount 100 may also comprise a leveling apparatus 176 that can be used to substantially level the base 104 before a mosaic image is captured. However, in certain embodiments, it may be desirable to not have the base 104 level when creating a mosaic image.

The camera mount 100 may further be equipped to communicate with, or have positioned thereon a controller that controls one or more servomotors that subsequently control the rotation of the swing mount about the first 136 and second 144 axes.

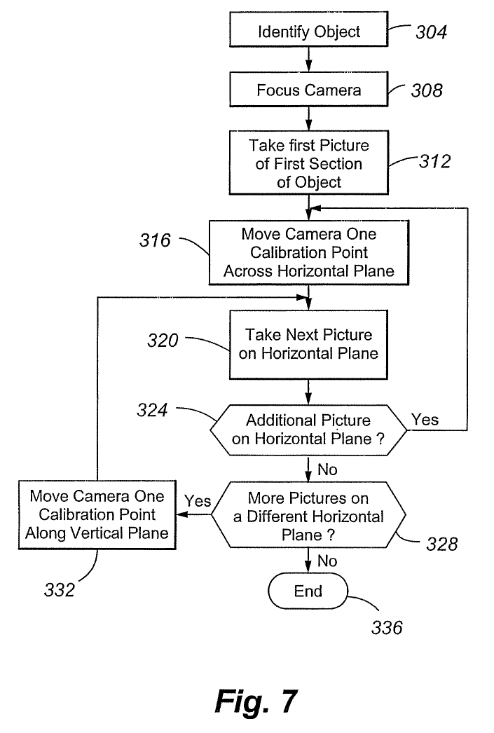

Referring now to FIG. 7 a method of creating a mosaic image will be described in accordance with at least some embodiments of the present invention. Initially an object is identified (step 304). An object may include, but is not limited to, any landscape, scenery, or distant objects. Alternatively, an object may be a single element like a flower, car, building, or the like. Once the object has been identified, the camera is focused, if desired, on the object (step 308). At that point a first picture can be taken of a first section of the object (step 312). Typically, the first picture is taken at a first calibration point, both in the horizontal plane and the vertical plane. The first picture is essentially a starting point for the mosaic, and can be either of a center section of the object or an edge portion of the object.

After the first picture has been taken, the camera is moved one calibration point across the horizontal plane (step 316). As can be appreciated, the next picture does not necessarily need to be taken across the horizontal plane. Rather, the next picture may be taken moving to the next calibration point along the vertical plane. Furthermore, there is no restriction that the next calibration point is adjacent to the first calibration point. In most cases the camera is moved to sequentially adjacent calibration points but this practice is not required.

Once the camera is positioned at the next calibration point, the next picture is taken (step 320). Again, this picture may be a picture that will ultimately go next to the first picture in the mosaic, although that is not necessary. Moreover, the next picture taken may be from a position adjacent to the first picture but it does not necessarily need to be placed next to the first picture in the final mosaic.

After the picture has been taken, it is determined if additional pictures are desired in the horizontal plane (step 324). In the event that more pictures are desired, then the method returns to step 316. In the event that no more pictures are desired in the current horizontal plane then it is determined if more pictures are desired from a different horizontal plane (step 328). If there is a desire for more pictures from a different horizontal plane, then the camera is moved one calibration point along the vertical plane to a second horizontal plane (step 332). Thereafter, the method returns to step 320 where pictures are taken along the second horizontal plane in a similar fashion to the way pictures were taken across the first horizontal plane. In the event that there are no more horizontal planes from which pictures are desired, then the method completes at step 336.

As can be appreciated by one of skill in the art, the sequential movement across one horizontal plane then to the next horizontal plane is not necessarily required. Rather, inventive aspects of the present invention, allow a user to easily move the camera to any one of a number of positions to take a picture. There does not need to be any methodology as to how the camera is positioned from one calibration point to the next. The calibration points simply provide a easily viewable and usable frame of reference that allows a camera to be moved from one position to the next with a high degree of accuracy and confidence.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of creating a mosaic image, comprising:
positioning a camera at a first point;
taking a first picture with the camera positioned at the first point;
moving the camera to a second point a calibrated angle away from the first point on a first axis;
taking a second picture with the camera positioned at the second point;
moving the camera to a third point a calibrated angle away from at least one of the first and second point on a second axis; and
taking a third picture with the camera positioned at the third point.

2. The method of claim 1, wherein the first axis is a substantially horizontal axis and wherein the second axis is a substantially vertical axis.

3. The method of claim 1, wherein the first and second axes are substantially perpendicular to one another.

4. The method of claim 1, further comprising:
identifying a plurality of calibrated positions for the camera about the first axis; and
moving the camera to each of the plurality of calibrated positions and taking a picture at each of the plurality of calibrated positions.

5. The method of claim 4, wherein the plurality of calibrated positions substantially span about 360 degrees around the camera about the first axis.

6. The method of claim 4, further comprising:
identifying a plurality of calibrated positions for the camera about the second axis; and
moving the camera to each of the plurality of calibrated positions about the second axis and taking a picture at each of the plurality of calibrated positions about the second axis.

7. The method of claim 6, wherein the plurality of calibrated positions about the second axis substantially span about 360 degrees around the camera about the second axis.

8. The method of claim 1, wherein each of the moving steps comprise keeping the optical focal point of the camera substantially still.

9. The method of claim 1, further comprising:
developing the first, second, and third pictures;
placing the second picture next to a first side of the first picture; and
placing the third picture next to a second side of the first picture.

10. The method of claim 9, wherein the first and second sides of the first picture are adjacent to one another.

11. A method of creating a mosaic image, comprising:
defining at least two positions a calibrated angle apart on a first plane;
taking a picture at each of the at least two positions on the first plane;
defining a second plane a calibrated angle offset from the first plane;
defining at least two positions on the second plane; and
taking a picture at each of the at least two positions on the second plane.

12. The method of claim 11, wherein the first and second plane are substantially parallel to one another.

13. The method of claim 11, wherein the first and second plane are substantially horizontal.

14. The method of claim 11, wherein the first and second plane are substantially vertical.

15. The method of claim 11, wherein defining a second plane comprises reading a calibration device having a number of marks, each mark defining a different plane, and identifying a mark adjacent to the mark representing the first plane.

16. The method of claim 11, wherein defining at least two positions along one of the first and second plane comprises reading a calibration device having a number of marks, each mark defining a different position, and identifying at least two marks adjacent to one another.

17. A camera mount, comprising:
a base with calibrations for controlled movement about a first axis;
a swing mount having calibrations for controlled movement about a second axis; and
wherein the swing mount is rotatable about the first axis relative to the base and is further rotatable about the second axis.

18. The mount of claim 17, wherein the swing mount is operable to receive a camera and adapt the position of the camera such that the first and second axis substantially intersect at an optical nodal point of the camera.

19. The mount of claim 17, wherein the swing mount comprises an outer yoke that is rotatable about the first axis and an inner yoke connected to the outer yoke that is rotatable about the second axis.

20. The mount of claim 17, wherein the first axis is a substantially vertical axis and wherein the second axis is a substantially horizontal axis.

21. The mount of claim 17, further comprising a turntable connecting the base to the swing mount.

22. The mount of claim 17, wherein the base is operable to be connected to a typical tripod camera mounting system.

23. The mount of claim 17, wherein the calibrations of at least one of the base and swing mount comprise at least one of printed lines, embossed lines, debossed lines, dots, and electromagnetic points identifying predefined angular positions for the swing mount.

24. The mount of claim 17, wherein the calibrations of at least one of the base and swing mount comprise a plurality of markings, wherein the angular spacing between adjacent ones of the plurality of markings is about the field of view of a camera attached to the swing mount.

25. The mount of claim 24, wherein the angular spacing between adjacent ones of the plurality of markings is different for the swing mount calibration as compared to the base calibration.

26. The mount of claim 17, further comprising a level attached to the base.

27. The mount of claim 17, wherein the base comprises an adjustment member that is operable to translate the swing mount relative to the first axis and wherein the swing mount comprises an adjustment member that is operable to translate a camera relative to the second axis.
